(19) United States
(12) Patent Application Publication
(10) Pub. No.: US 2020/0341696 A1
(43) Pub. Date: Oct. 29, 2020

(54) IMAGE FORMING SYSTEM, PHOTOGRAPHING DEVICE, IMAGE FORMING DEVICE AND NON-TRANSITORY RECORDING MEDIUM

(71) Applicant: Konica Minolta, Inc., Tokyo (JP)

(72) Inventor: Yoshiaki Shibuta, Itami-shi (JP)

(73) Assignee: Konica Minolta, Inc., Tokyo (JP)

(21) Appl. No.: 16/844,260

(22) Filed: Apr. 9, 2020

(30) Foreign Application Priority Data
Apr. 26, 2019 (JP) 2019-084871

(51) Int. Cl. G06F 3/12; G06T 7/70; H04N 5/247; H04N 5/232; G06K 9/00

(52) U.S. Cl. CPC G06F 3/1203; G06T 7/70; H04N 5/247; G06F 3/1286; G06K 9/00624; G06K 9/00362; G06F 3/126; H04N 5/23299

(57) ABSTRACT

An image forming system includes: an image forming device that produces a printed output based on a print job sent by an information processing device; and a photographing device arranged at a position in which a photographing of the image forming device is enabled. The image forming device and the photographing device communicate with each other over a network. The image forming device includes a hardware processor that: obtains device information that identifies the information processing device that hast sent the print job; and sends the device information to the photographing device. The photographing device includes: an imaging device that photographs an image that identifies a location of the image forming device; and a hardware processor that sends the image photographed by the imaging device to the information processing device based on the device information.

### CROSS-REFERENCE TO RELATED APPLICATIONS

Japanese patent application No. 2019-084871 filed on Apr. 26, 2019 including description, claims, drawings, and abstract the entire disclosure is incorporated herein by reference.

### BACKGROUND

### Technical Field

The present invention relates to an image forming system a photographing device, an image forming device and a non-transitory recording medium. The present invention more specifically relates to a technique that provides a user with information of the image forming device that produced a printed output.

### Description of the Related Art

Multiple numbers of image forming devices such as MFPs (Multifunction Peripherals) may be installed in an environment such as an office. The multiple image forming devices are generally connected to a network such as LAN (Local Area Network) in the office. A user operates an information processing device such as a PC to select one of the image forming devices connected to the network and send a print job to the selected image forming device. The image forming device then processes the print job to produce a printed output.

In the environment where the multiple image forming devices are connected to the network, the user sometimes selects the wrong image forming device which is different from the one he or she wants to send the print job to and sends the print job to the wrong image forming device. In such a case, the user cannot find out a location of the wrong image forming device. The user operates the information processing device to see a network structure of devices connected to the network. The network structure, however, is not information that shows physical locations of the devices connected to the network. Even though the user sees the network structure, he or she cannot easily find out the location of the image forming device he or she sent the print job to.

A way of preventing the wrong image forming device to be selected when the user selects one of the multiple image forming devices is conventionally known. This known technique is introduced for example in Japanese Patent Application Laid-Open No. JP 2008-141275 A. According to the known technique, for sending a fax, the user operates a terminal of a transmitter side to select a terminal of a recipient side that receives the fax. The terminal of the transmitter obtains an image that enables an identification of the terminal of the recipient from the terminal of the recipient and displays the obtained image on a display unit of the terminal of the transmitter. The user sees the image displayed on the display unit of the terminal of the transmitter so that he or she is allowed to confirm if the selecting device as the terminal of the recipient is the right one prior to the fax transmission.

According to the known technique, the image for the identification of the terminal of the recipient needs to be stored in advance in the terminal of the recipient. If the image for the identification of the terminal of the recipient is not stored in the terminal of the recipient, the terminal of the transmitter cannot obtain the image that enables the identification of the terminal of the recipient. Even though the user selects the terminal of the recipient as a destination of the fax transmission, he or she is not allowed to check the image corresponding to the selected terminal of the recipient. The user may select the wrong terminal of the recipient as the destination of the fax. The image stored in advance in the terminal of the recipient only enables the identification of the terminal of the recipient and does not always show the physical location of the terminal of the recipient.

### SUMMARY

One or more embodiments of the present invention provide an image forming system, a photographing device, an image forming device and a non-transitory recording medium that provide a user with information of the image forming device to which the user sent a print job.

First, one or more embodiments of the present invention are directed to an image forming system.

According to one or more embodiments of the present invention, the image forming system comprises: an image forming device and a photographing device. The image forming device produces a printed output based on a print job sent by an information processing device. The photographing device is arranged at a position in which a photographing of the image forming device is enabled. The image forming device and the photographing device are connected over a network to enable communication with each other. The image forming device comprises a hardware processor that: obtains device information that enables to identify the information processing device to send the print job; and sends the obtained device information to the photographing device upon receiving the print job. The photographing device comprises: a photographing part (or imaging device) that photographs an image that enables to identify a location of the image forming device; and a hardware processor that sends the image photographed by the photographing part to the information processing device based on the device information upon receiving the device information from the image forming device.

Second, one or more embodiments of the present invention are directed to a photographing device that communicates over a network. The photographing device is arranged at a position in which a photographing of an image forming device is enabled. The image forming device produces a printed output based on a print job sent by an information processing device.

According to one or more embodiments of the present invention, the photographing device comprises: a photographing part (or imaging device) that photographs an image that enables to identify of a location of the image forming device; and a hardware processor that: obtains device information that enables to identify the information processing device, used by the user to send the print job, from the image forming device which received the print job; and sends the image photographed by the photographing part to the information processing device based on the device information upon obtaining the device information.

Third, one or more embodiments of the present invention are directed to an image forming device that communicates over a network with a photographing device which is enabled to photograph the image forming device.

According to one or more embodiments of the present invention, the image forming device comprises: a hardware processor that: obtains device information that enables to identify an information processing device to send a print job; sends the obtained device information to the photographing device upon receiving the print job; enables the photographing device to photograph an image that enables to identify a location of the image forming device; and enables the photographing device to send the photographed image to the information processing device based on the device information.

Fourth, one or more embodiments of the present invention are directed to a non-transitory recording medium storing a computer readable program to be executed by a hardware processor in a photographing device that communicates over a network and being arranged at a position in which a photographing of an image forming device is enabled. The image forming device produces a printed output based on a print job sent by an information processing device.

According to one or more embodiments of the present invention, the non-transitory recording medium stores the computer readable program, execution of the computer readable program by the hardware processor causing the hardware processor in the photographing device to perform: photographing an image that enables to identify a location of the image forming device; obtaining device information that enables to identify the information processing device, used by the user to send the print job, from the image forming device which received the print job; and sending the photographed image to the information processing device based on the device information upon obtaining the device information.

Fifth, one or more embodiments of the present invention are directed to a non-transitory recording medium storing a computer readable program to be executed by a hardware processor in an image forming device that communicates over a network with a photographing device which is enabled to photograph the image forming device.

According to one or more embodiments of the present invention, the non-transitory recording medium stores the computer readable program, execution of the computer readable program by the hardware processor causing the hardware processor in the image forming device to perform: obtaining device information that enables to identify an information processing device to send a print job; sending the obtained device information to the photographing device upon receiving the print job; enabling the photographing device to photograph an image that enables to identify a location of the image forming device; and enabling the photographing device to send the image to the information processing device based on the device information.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary appearance structure of an image forming system according to one or more embodiments;

FIG. 2 illustrates an example of an installation of the image forming system according to one or more embodiments;

FIG. 3 is a flow diagram showing an exemplary operation performed when the image forming system informs a user of a location of an image forming device according to one or more embodiments;

FIG. 4 illustrates a block diagram showing an example of the hardware structure and the functional structure of the image forming device according to one or more embodiments;

FIG. 5 illustrates an exemplary appearance structure of a photographing device according to one or more embodiments;

FIG. 6 illustrates a block diagram showing an example of the hardware structure and the functional structure of the photographing device according to one or more embodiments;

FIG. 7 illustrates an example of related information according to one or more embodiments;

FIG. 8 illustrates an example of location relation information according to one or more embodiments;

FIG. 9 illustrates an example of destination information according to one or more embodiments;

FIG. 10 illustrates an example of a photographed image sent to an information processing device by an image transmitter according to one or more embodiments;

FIGS. 11 A and 11B illustrate an example of map information prior to edition according to one or more embodiments;

FIGS. 12A and 12B illustrate an example of the map information generated by a map information editor according to one or more embodiments;

FIG. 13 illustrates an example of the photographed image displayed on a display unit of the information processing device according to one or more embodiments;

FIG. 14 illustrates a flow diagram explaining an exemplary procedure of a main process performed by the image forming device according to one or more embodiments;

FIG. 15 illustrates a flow diagram explaining an exemplary procedure of a main process performed by the photographing device according to one or more embodiments;

FIG. 16 illustrates a flow diagram explaining an exemplary procedure of a highlighting process performed by the photographing device according to one or more embodiments;

FIG. 17 is a flow diagram showing an exemplary operation performed when the image forming system informs the user of the location of the image forming device according to one or more embodiments;

FIG. 18 illustrates a block diagram showing an example of the hardware structure and the functional structure of the image forming device according to one or more embodiments; and

FIG. 19 illustrates a flow diagram explaining an exemplary procedure of a main process performed by the image forming device according to one or more embodiments.

### DETAILED DESCRIPTION OF EMBODIMENTS

Hereinafter, embodiments of the present invention will be described with reference to the drawings. However, the scope of the invention is not limited to the disclosed embodiments.

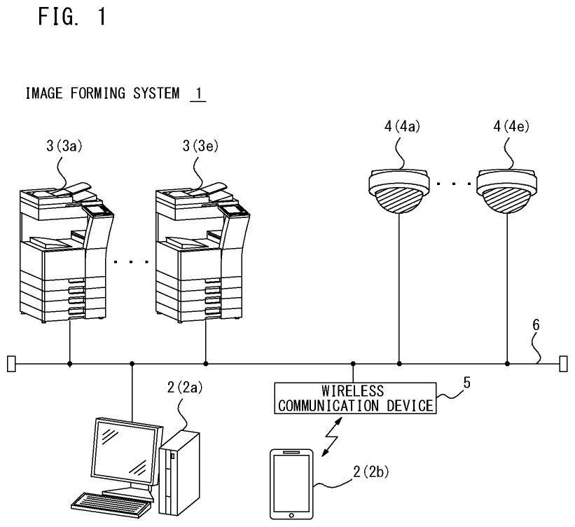

FIG. 1 illustrates an exemplary appearance structure of an image forming system 1 according to one or more embodiments. The image forming system 1 is established in an office, for example, and includes multiple information processing devices 2, multiple image forming devices 3, multiple photographing devices 4 and a wireless communication device 5. The information processing devices 2, the image forming devices 3 and the photographing devices 4 are connected to enable communication with each other over a network 6 such as LAN.

The wireless communication device 5 establishes communication based on a wireless LAN standard such as Wi-Fi, for example. The wireless communication device 5 communicates with various kinds of devices that are equipped with a wireless communication function to enable the devices to have connections with the network 6.

The information processing device 2 constructed by a device such as a personal computer (PC), a smartphone or a tablet terminal including an information processing function. The information processing device 2 is used by a user. In one or more embodiments, two information processing devices 2 are connected to the network 6 as an example. The multiple information processing devices 2 include information processing devices 2a and 2b. The information processing device 2a is constructed by a device such as a personal computer and the information processing device 2b is constructed by a portable device such as a smartphone or a tablet terminal. The information processing devices 2a and 2b of one or more embodiments are used by the same user. In one or more embodiments, the information processing devices 2a and 2b are simply stated as the information processing device 2 if the differentiation between them is not necessary. The multiple information processing devices 2 of one or more embodiments include information processing devices 2a and 2b, for example.

However, this is given not for limitation. Any number of information processing devices 2 may be installed. The information processing device 2b is enabled to establish a wireless LAN communication such as Wi-Fi. The information processing device 2b is enabled to have a connection to the network 6 via the wireless communication device 5. The information processing device 2b is enabled to communicate with the image forming device 3 and/or the photographing device 4 from anywhere in the office if it is within a range that allows connection to the network 6.

The information processing device 2 is equipped with a function to send a job such as a print job to the image forming device 3. A driver program, for instance, corresponding to the image forming device 3 is installed in the information processing device 2. The information processing device 2 executes the driver program to send the job such as the print job to the image forming device 3. The information processing device 2 includes a display unit on which a variety of information is displayed. Information such as an image obtained over the network 6, for example, is displayed on the display unit. The information processing device 2 also is equipped with a browser to display a web page. The information processing device 2 is enabled to obtain an image created as a web page and display the obtained image on the display unit.

The image forming device 3 is constructed by a device such as one of MFPs, for instance. The image forming device 3 includes multiple functions such as a scan function, a print function, a copy function and a fax function. The image forming device 3 activates the function corresponding to a job specified by the user so that it is enabled to process a variety of jobs including a scan job, a print job, a copy job and a fax job. In response to receiving the print job from the information processing device 2 over the network 6, the image forming device 3 processes the received print job so that it is enabled to produce a printed output based on the print job. In one or more embodiments, five image forming devices 3a, 3b, 3c, 3d and 3e are connected to the network 6 as an example. However, this is given not for limitation. The number of the installed image forming devices 3 may be any number but has to be more than one. In one or more embodiments, the image forming devices 3a, 3b, 3c, 3d and 3e are simply stated as the image forming device 3 if the differentiation between them is not necessary.

The photographing device 4 constructed by an electronic camera including a still camera or a moving camera, for instance, is enabled to photograph a still image or a moving image. The photographing device 4 includes a communication interface to have a connection to the network 6. The photographing device 4 is enabled to send the photographed image to another device such as the information processing device 2 over the network 6. In one or more embodiments, five photographing devices 4a, 4b, 4c, 4d and 4e are connected to the network 6 as an example. However, this is given not for limitation. The number of the installed photographing devices 4 may be any number but has to be more than one. In one or more embodiments, the photographing devices 4a, 4b, 4c, 4d and 4e are simply stated as the photographing device 4 if the differentiation between them is not necessary.

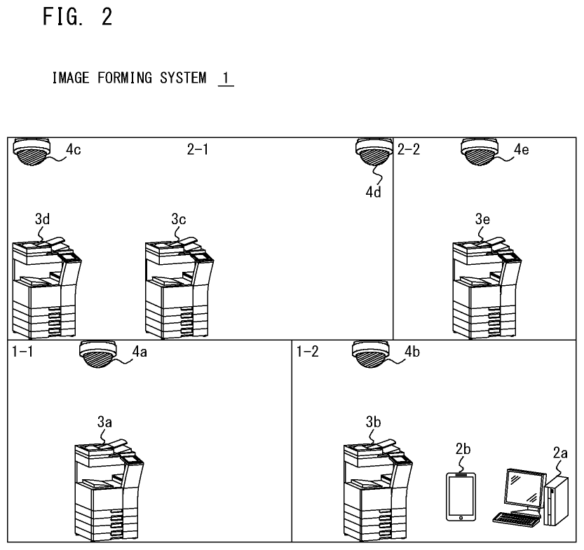

Each device included in the aforementioned image forming system 1 is located in a variety of places in an environment such as an office, for example. FIG. 2 illustrates an example of an installation of the image forming system 1. As illustrated in FIG. 2, the image forming system 1 of one or more embodiments is established in an environment which has four rooms, rooms 1-1, 1-2, 2-1 and 2-2. In the example of FIG. 2, the image forming device 3a and the photographing device 4a are installed in the room 1-1, and the information processing devices 2a and 2b, the image forming device 3b and the photographing device 4b are installed in the room 1-2. The image forming devices 3c and 3d and the photographing devices 4c and 4d are installed in the room 2-1, and the image forming device 3e and the photographing device 4e are installed in the room 2-2. As already described above, the information processing device 2b is portable by the user so that he or she is allowed to carry the information processing device 2b and move between the rooms. In this environment, the user operates the information processing device 2a or 2b to send the print job to any of the image forming devices 3a, 3b, 3c, 3d and 3e. The user sometimes willing to send the print job to the image forming device 3b sends the print job to the wrong image forming device 3a by mistake. In such a case, the user may not be able to figure out to what image forming device 3 he or she has sent the print job to, or the location of the image forming device 3 to which he or she has sent the print job. The image forming system 1 of one or more embodiments enables the photographing device 4 to photograph the image forming device 3 to which he or she has sent the print job, and sends the photographed image to the information processing device 2 used by the user. The user then is allowed to be informed of an external appearance and/or the location of the image forming device 3. An overview of operations of the image forming system 1 is described next.

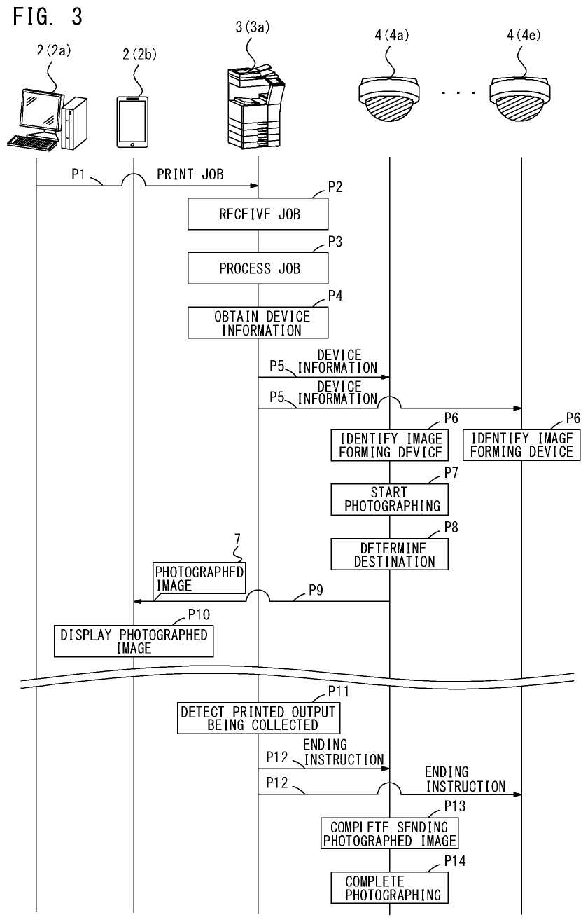

FIG. 3 is a flow diagram showing an exemplary operation performed when the image forming system 1 informs the user of the location of the image forming device 3. The user operates the information processing device 2a to send the print job to the image forming device 3a (process P1). After receiving the print job (process P2), the image forming device 3a processes the received print job to produce a printed output (process P3). The image forming device 3a then obtains device information that enables to identify the information processing device 2a used by the user to send the print job (process P4). The device information that enables the identification of the information processing device 2a is address information of an IP address, for instance, of the information processing device 2 obtained from data such as a header of the print job. In response to obtaining the device information of the information processing device 2a, the image forming device 3a broadcasts the obtained device information to all devices connected to the network 6 (process P5). In the example of FIG. 3, the device information is sent to the photographing devices 4a to 4e. In an accrual case, the device information is also sent to the information processing device 2 and the image forming devices 3b to 3e which are not shown in FIG. 3. When the devices other than the photographing unit 4 receive the device information, they may discard the received device information. The devices other than the photographing unit 4 do not have any procedure to process based on the obtained device information even if they receive the information about the information processing device 2a.

After receiving the device information of the information processing device 2a, the photographing device 4 identifies the image forming device 3a which is a transmitter of the device information (the image forming device 3a that processed the print job) (process P6). To be more specific, the photographing device 4 obtains identification information that enables to identify the image forming device 3a that processed the print job, and identifies the image forming device 3a that processed the print job based on the obtained identification information. In one or more embodiments, the photographing device 4 refers to an IP header added for transmission of the device information of the information processing device 2a by the image forming device 3a so that it may obtain the address information such as the IP address of the image forming device 3a which is the transmitter of the device information as the identification information. In the example of FIG. 3, the photographing device 4 identifies the image forming device 3a of the multiple image forming devices 3a to 3e based on the identification information. After identifying the image forming device 3a, the photographing device 4 determines if it can photograph the identified image forming device 3a. In the example of FIG. 2, the image forming device 3a is placed in the room 1-1 and the photographing device 4a is also placed in the same room 1-1. The photographing device 4a determines it may photograph the image forming device 3a placed in the same room. The other photographing devices 4b to 4e placed on the other rooms determine they are not able to photograph the image forming device 3a. After determining it may photograph the image forming device 3a, the photographing device 4a starts photographing the image forming device 3a (process P7). The photographing device 4a photographs an image that enables to identify the location of the image forming device 3a. The photographing device 4, for example, photographs the image to include not only the image forming device 3a but also a landscape around the image forming device 3a. The photographing device 4 of one or more embodiments photographs the moving image.

The photographing device 4a determines the information processing device 2 of the user who has sent the job as a destination of the photographed image based on the device information such as the IP address of the information processing device 2a and destination information described later (process P8). The photographing device 4a refers to the device information of the information processing device 2a and the destination information, and is enabled to identify the information processing device 2 to which the photographed image is to be sent. In the example of FIG. 3, the photographing device 4a determines the information processing device 2b as the destination of a photographed image 7 of the information processing devices 2a used by the user to send the print job. As described above, the information processing device 2b is portable by the user. The information processing device 2b is determined as the destination of the photographed image 7 so that the photographed image 7 is sent to the portable information processing device 2b. The user is enabled to move to the location of the image forming device 3a looking at the photographed image 7 displayed on the display unit of the information processing device 2b. A way of determining the destination of the photographed image 7 applied at the photographing device 4 is explained in detail later. After determining the information processing device 2 to send the photographed image 7, the photographing device 4a starts sending the photographed image 7 to the information processing device 2b (process P9).

Upon receiving the photographed image 7 from the photographing device 4a, the information processing device 2b displays the received photographed image 7 on the display unit (process P10). The user is then allowed to see the photographed image 7 displayed on the display unit of the information processing device 2b so that he or she is allowed to find out the location of the image forming device 3a that processed the print job. Once the user collects the printed output produced by the image forming device 3a, there will be no printed output on a paper delivery tray. The image forming device 3a detects that the printed output is collected (process P11), and broadcasts an instruction to end the photographing (hereafter, ending instruction) to all devices connected to the network 6 (process P12). In the example of FIG. 3, the transmission of the ending instruction to the devices other than the photographing devices 4a to 4e is not shown. In the real process, the ending instruction is sent to the information processing device 2 and the image forming devices 3b to 3e which are not shown in FIG. 3. When the devices other than the photographing device 4 receive the ending instruction, they may discard the received ending instruction. The devices other than the photographing device 4 do not have any process to perform in response to receiving the ending instruction. The photographing device 4a received the ending instruction completes the transmission of the photographed image 7 (process P13), and completes the photographing of the image forming device 3a (process P14).

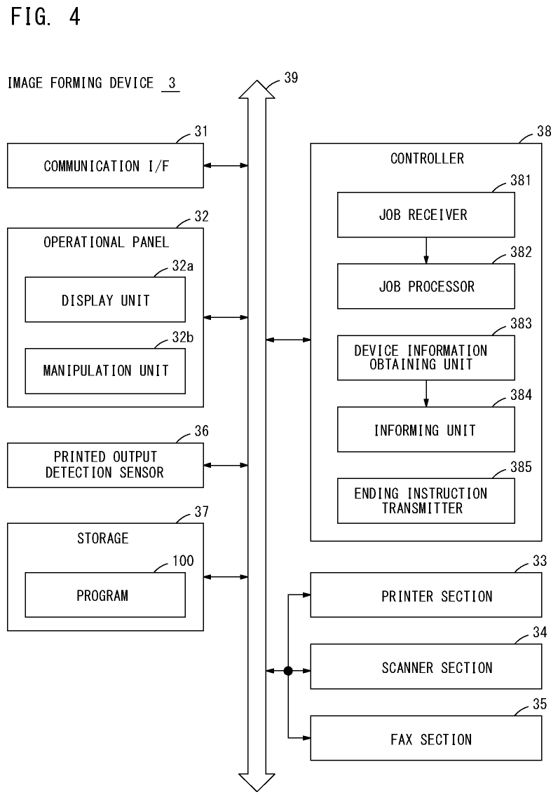

The detailed structures and operations of the image forming device 3 and the photographing device 4 that form the image forming system 1 as described above are explained next. The image forming device 3 is explained first. FIG. 4 illustrates a block diagram showing an example of the hardware structure and the functional structure of the image forming device 3. As its hardware structure, the image forming device 3 includes a communication interface 31, an operational panel 32, a printer section 33, a scanner section 34, a fax section 35, a printed output detecting sensor 36, a storage 37 and a controller (or hardware processor) 38. These parts are enabled to input and output data to and from each other via a data bus 39.

The communication interface 31 connects the image forming device 3 to the network 6. The image forming device 3 communicates with the information processing device 2 and/or the photographing device 4 via the communication interface 31.

The operational panel 32 includes a display unit 32a and a manipulation unit 32b. The display unit 32a is constructed by a device such as a color liquid crystal display, for instance. A variety of screens operable for the user and prompting the user to operate are displayed on the display unit 32a. The manipulation unit 32b receives an operation by the user. The manipulation unit 32b is constructed by parts such as a touch panel key arranged on the display area of the display unit 32a and/or push-button keys arranged around the display area of the display unit 32a.

The printer section 33 forms an image on a sheet type recording material based on input image data, and produces a printed output. The printer section 33 is brought into operation when a print job, a copy job or a fax receiving job, for example, is processed. The printer section 33 forms an image on the sheet type recording material and produces a printed output.

The scanner section 34 optically reads a document placed by the user and generates image data. The scanner section 34 is brought into operation when a print job, a copy job or a fax receiving job, for example, is processed. The scanner section 34 reads the document.

The fax section 35 transmits and receives fax data over public phone lines that are not shown in FIG. 4.

The printed output detecting sensor 36 is provided on the paper delivery tray which is not illustrated in FIG. 4, for instance. The printed output detecting sensor 36 detects the printed output delivered on the paper delivery tray. The detection of the printed output on the paper delivery tray by the printed output detecting sensor 36 means that the printed output produced by the image forming device 3 is still on the paper delivery tray and not being collected. The printed output detecting sensor 36 is used to detect if the printed output produced by the image forming device 3 is collected. The printed output detecting sensor 36 is formed from a contact sensor that detects based on a weight of the printed output delivered on the paper delivery tray or a noncontact sensor that detects if there is the printed output using a light or an ultrasonic wave.

The storage 37 is formed from a non-volatility device such as a hard disk drive (HDD) or a solid-state drive (SDD), for example. A program 100 is stored in advance in the storage 37, for example.

The controller 38 includes a CPU and a memory, which are not illustrated in FIG. 4. The CPU reads and executes the program 100. The memory stores temporary data generated when the CPU executes the program 100. When the image forming device 3 is powered, the CPU reads and executes the program 100 in the storage 37. The controller 38 then serves as a job receiver 381, a job processor 382, a device information obtaining unit 383, an informing unit 384 and an ending instruction transmitter 385. Each of these parts is described in detail below.

The job receiver 381 receives the print job sent from the information processing device 2 over the network 6. Upon receiving the print job, the job receiver 381 outputs the received print job to the job processor 382.

The job processor 382 becomes operative when the job is sent by the user. The job processor 382 drives the printer section 33, the scanner section 34 and/or the fax section 35 based on the received job to process the job. It is assumed that the print job is received from the job receiver 381, for instance, the job processor 382 drives the printer section 33 based on the print job to produce the printed output.

The device information obtaining unit 383 obtains the device information which enables to identify the information processing device 2 used by the user to send the print job when the print job is received by the job receiver 381. The device information obtaining unit 383 obtains the device information based on the print job received by the job receiver 381. The device information is the address information such as an IP address of the information processing device 2 obtained from a header of the print job, for example. Alternatively, the device information may be address information such as a MAC address (Media Access Control). Upon obtaining the device information, the device information obtaining unit 383 outputs the obtained device information to the informing unit 384.

The informing unit 384 sends the device information obtained by the device information obtaining unit 383 to the photographing device 4. Upon receiving the device information of the information processing device 2 from the device information obtaining unit 383, the informing unit 384 sends the received device information to the photographing device 4. The informing unit 384 of one or more embodiments broadcasts the received device information to all devices connected to the network 6 to send the device information to the photographing device 4. The informing unit 384 broadcasts the device information of the information processing device 2 so that it may send the device information to the photographing device 4 whose IP address is unknown. To be more specific, it is not necessary to store the device information such as the IP address of the photographing device 4 in advance in the image forming device 3. The photographing device 4 that received the device information of the information processing device 2 may be enabled to photograph the image forming device 3 which is the transmitter of the device information. In this case, the photographing device 4 photographs the image that enables the identification of the location of the image forming device 3 and sends the photographed image 7 to the information processing device 2 used by the user.

The ending instruction transmitter 385 sends the instruction to end the photographing of the photographed image 7 to the photographing device 4. After the informing unit 384 sends the device information of the information processing device 2 to the photographing device 4, the ending instruction transmitter 385 becomes operative next. The ending instruction transmitter 385 checks on a periodical basis if the printed output on the paper delivery tray is detected by the printed output detection sensor 36. No printed output may be detected by the printed output detection sensor 36. In this case, the ending instruction transmitter 385 broadcasts the ending instruction to end the photographing of the image forming device 3 to all of the photographing devices 4. Upon receiving the ending instruction from the ending instruction transmitter 385, the photographing device 4 which is photographing the image forming device 3 completes the photographing of the image forming device 3. At the same time, the photographing device 4 completes transmission of the photographed image 7 to the information processing device 2. As a result, the photographing device 4 does not have to keep sending the photographed image 7 to the information processing device 2 even after the printed output is collected by the user. This ending instruction may be sent to the photographing device 4 from the information processing device 2 in response to the user's operation to the information processing device 2. Alternatively, the photographing device 4 capable of photographing the image forming device 3 may send a reply to the image forming device 3 in response to the receipt of the device information from the image forming device 3 and the ending instruction transmitter 385 may only send the ending instruction to the photographing device 4 which sent the reply to the image forming device 3.

As described above, upon processing the print job received from the information processing device 2, the image forming device 3 of one or more embodiments obtains the device information that enables to identify the information processing device 2, which is the transmitter of the print job, and sends the obtained device information to the photographing device 4. The photographing device 4 receives the device information of the information processing device 2, and photographs the image forming device 3. The photographing device 4 then sends the photographed image to the information processing device 2.

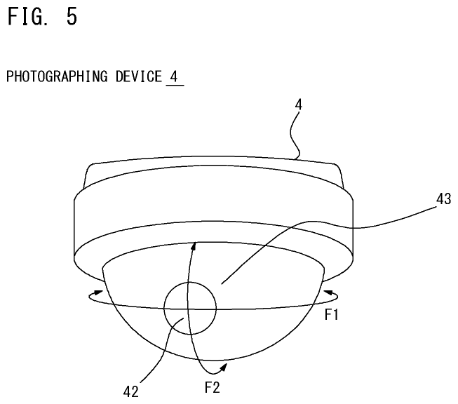

The photographing device 4 is explained next. FIG. 5 illustrates an exemplary appearance structure of the photographing device 4. The photographing device 4 is arranged at a position in which the photographing of the image forming device 3 is allowed. The photographing device 4 of one or more embodiments is arranged on a ceiling of a room in which the image forming device 3 is placed, for example. The photographing device 4 includes a photographing unit 42 and a photographing direction adjusting unit (or photographing direction controller) 43 inside its body. The photographing unit 42 is constructed by an imaging device such as CCD (Charge Coupled Device) that converts a subject light into an electronic signal and an optical system including a photographing lens that leads the subject light to the optical system. The photographing unit 42 is enabled to change a focal distance and a magnification of the photographing lens. The photographing direction adjusting unit 43 comprises a CPU and a mempry, and is enabled to adjust a direction in which the photographing unit 42 photographs. The photographing direction adjusting unit 43 of one or more embodiments rotates the photographing unit 42 in a pan direction (an arrow F1 direction of FIG. 5) and a tilt direction (an arrow F2 direction of FIG. 5) to enable the photographing unit 42 to photograph in any direction.

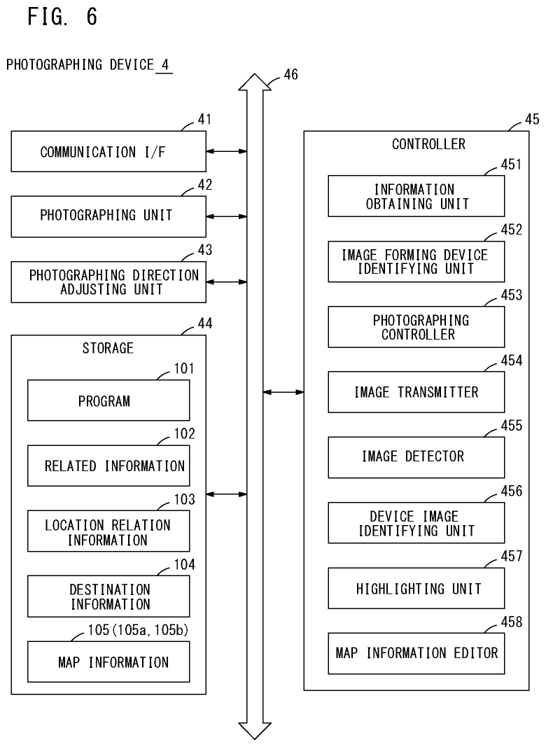

FIG. 6 illustrates a block diagram showing an example of the hardware structure and the functional structure of the photographing device 4. As its hardware structure, the photographing device 4 includes a communication interface 41, a storage 44 and a controller (or hardware processor) 45. These parts are enabled to input and output of data to and from each other via a data bus 46.

The communication interface 41 connects the photographing device 4 to the network 6. The photographing device 4 communicates with the information processing device 2 and/or the image forming device 3 via the communication interface 41.

The storage 44 is formed from a non-volatility device such as a hard disk drive (HDD) or a solid-state drive (SDD), for example. A program 101, related information 102, location relation information 103, destination information 104 and map information 105 (105a and 105b) is stored in the storage 44, for example.

The controller 45 includes a CPU and a memory, which are not illustrated in FIG. 6. The CPU reads and executes the program 101. The memory stores temporary data generated when the CPU executes the program 101. When the photographing device 4 is powered, the CPU reads and executes the program 101 in the storage 44. The controller 45 then serves as an information obtaining unit 451, an image forming device identifying unit 452, a photographing controller 453, an image transmitter 454, an image detector 455, a device image identifying unit 456, a highlighting unit 457 and a map information editor 458. Each of these parts is described in detail below.

The information obtaining unit 451 obtains a variety of information required when providing with the photographed image 7 which is to inform the user of the location of the image forming device 3 that processed the print job. The information obtaining unit 451 obtains the device information (address information) such as the IP address that enables to identify the information processing device 2 used by the user to send the print job from the image forming device 3. In one or more embodiments, the device information of the information processing device 2 is sent from the image forming device 3 that processed the print job. The information obtaining unit 451 receives and obtains the device information of the information processing device 2 from the image forming device 3. The information obtaining unit 451 also obtains the identification information that enables to identify the image forming device 3 that processed the print job. More in detail, the information obtaining unit 451 refers to an IP header of the received device information so that it may obtain the address information such as the IP address that enables to identify the image forming device 3 that sent the device information as the identification information. The identification information may be address information of an address such as MAC (Media Access Control). The information obtaining unit 451 stores the device information of the information processing device 2 and the identification information of the image forming device 3 thereby obtained in the memory which is not shown in FIG. 6. The information obtaining unit 451 obtains in advance each of the related information 102, the location relation information 103, the destination information 104 and the map information 105 (105a and 105b) from a server, for instance, connected to the network 6 and stores the obtained information in the storage 44. The server is not illustrated in FIG. 6. The related information 102, the location relation information 103, the destination information 104 and the map information 105 (105a and 105b) is generated in advance by an administrator of the image forming system 1 or the user, and stored in advance in the server.

The image forming device identifying unit 452 identifies one of the multiple image forming devices 3 that processed the print job based on the identification information obtained by the information obtaining unit 451 and the related information 102 in the storage 44. The image forming device identifying unit 452 of one or more embodiments identifies the image forming device 3 that processed the print job of the multiple image forming devices 3 based on the identification information such as the IP address of the image forming device 3. The image forming device identifying unit 452 becomes operative when the identification information of the image forming device 3 is obtained by the information obtaining unit 451. The image forming device identifying unit 452 then receives the identification information from the information obtaining unit 451. The image forming device identifying unit 452 identifies the image forming device 3 that processed the print job based on the received identification information and the related information 102 stored in the storage 44. The photographing devices 4 that are enabled to photograph the respective image forming devices 3 are defined in the related information 102.

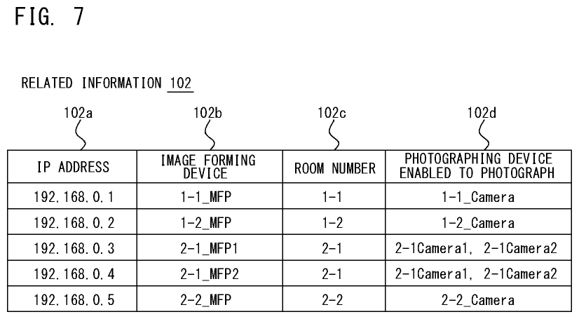

FIG. 7 illustrates an example of the related information 102. As illustrated in FIG. 7, an IP address 102a of the image forming device 3, a name 102b of the image forming device 3, a room number 102c in which the image forming device 3 is placed, and a name of the photographing device 102d that is enabled to photograph the image forming device 3 corresponding to each other is defined in the related information 102. It is assumed, for example, that the identification information obtained by the information obtaining unit 451 shows an IP address “192.168.0.1.” In this case, the image forming device identifying unit 452 refers to the IP address 102a of the image forming device 3 that has the IP address of “192.168.0.1.” The image forming device identifying unit 452 refers to the name 102b of the image forming device 3 corresponding to the IP address 102a of the image forming device 3 that has the IP address of “192.168.0.1.” The image forming device identifying unit 452 then confirms that the name of the image forming device 3 that has the IP address of “192.168.0.1” is “1-1_MFP.” Thus, the image forming device identifying unit 452 is enabled to identify the image forming device 3 that processed the print job is “1-1_MFP.” As described above, the image forming device identifying unit 452 refers to the related information 102 as illustrated in FIG. 7 to identify the image forming device 3 that processed the print job among from the multiple image forming devices 3 based on the identification information of the image forming device 3.

Upon identifying the image forming device 3 that processed the print job, the image forming device identifying unit 452 refers to the name of the photographing device 102d that is enabled to photograph the image forming device 3, the information of which is included in the related information 102. The image forming device identifying unit 452 then determines if the photographing device 4 in which itself is included is enabled to photograph the image forming device 3. It is assumed, for example, that the identified image forming device 3 is “1-1_MFP.” The image forming device identifying unit 452 refers to the name of the photographing device 102d that is enabled to photograph the image forming device 3 corresponding to the “1-1_MFP.” In the example of FIG. 7, “1-1_Camera” is registered as the photographing device 4 which is enabled to photograph “1-1_MFP.” Hence, if the photographing device 4 in which the image forming device identifying unit 452 itself is included is “1-1_Camera,” the image forming device identifying unit 452 determines it is enabled to photograph the identified image forming device 3. After determining the photographing device 4 in which the image forming device identifying unit 452 itself is included is enabled to photograph the identified image forming device 3, the image forming device identifying unit 452 outputs information indicating the name of the identified image forming device 3 to the photographing controller 453. When determining the photographing device 4 in which the image forming device identifying unit 452 itself is included is not enabled to photograph the identified image forming device 3, the image forming device identifying unit 452 does not output the information indicating the name of the identified image forming device 3 to the photographing controller 453.

Information of the room in which the corresponding image forming device 3 is placed is registered as the room number 102c in the related information 102. The image transmitter 454 uses the room number 102c as the location information to indicate the user of the location of the image forming device 3 that processed the print job.

The multiple photographing devices 4 may be installed in the single room. In one or more embodiments, each photographing device 4 of the multiple photographing devices 4 is installed to photograph the image forming device 3 located in the same room. Each photographing device 4 photographs the image forming device 3 that processed the print job, and sends the photographed image 7 to the information processing device 2. The information processing device 2 displays the received more than one photographed image 7 on the display unit to enable the user to see the more than one photographed image 7 photographed by the different photographing device 4. As a result, the user can easily find out the location of the image forming device 3 to which he or she sent the print job. Alternatively, the single photographing device 4 may be registered corresponding to the image forming device 3 as the subject of photographing. Even when there are multiple photographing devices 4 that are enabled to photograph the image forming device 3, the single photographing device 4 photographs the image forming device 3 and sends the photographed image 7 to the information processing device 2. In such a case, multiple photographed images 7 are not sent to the information processing device 2 used by the user, resulting in decrease in a communication amount of the network 6 and the information processing device 2.

The photographing controller 453 controls the photographing unit 42 and the photographing direction adjusting unit 43. The photographing direction adjusting unit 43 adjusts the photographing direction of the photographing unit 42 to settle the image forming device 3 identified by the image forming device identifying unit 452 within a range of photographing by the photographing unit 42. Upon inputting the information indicating the name of the image forming device 3 that processed the print job from the image forming device identifying unit 452, the photographing controller 453 refers to the location relation information 103 to calculate a relation between the locations of the devices. The location relation information 103 shows a relation between the locations of the photographing device 4 in which the photographing controller 453 is included and the image forming device 3 that processed the print job. The photographing controller 453 determines the photographing direction in which the image forming device 3 that processed the print job is settled within the range of photographing by the photographing unit 42 based on the calculated location relation.

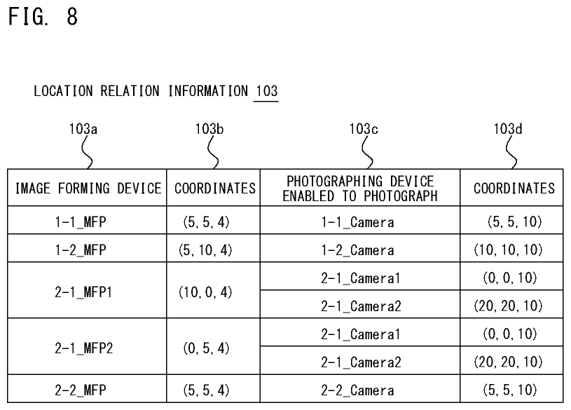

FIG. 8 illustrates an example of the location relation information 103. As illustrated in FIG. 8, a name 103a of the image forming device 3, coordinates 103b of the location in which the image forming device 3 is placed, a name of the photographing device 103c that is enabled to photograph the image forming device 3 and coordinates 103d of the location in which the photographing device 4 is installed corresponding to each other is defined in the location relation information 103. The coordinates of the location of the image forming device 3 in each room is registered as the coordinates 103b of the image forming device 3. The coordinates of the location of the photographing device 4 that is enabled to photograph the image forming device 3 and is installed in the same room as the corresponding image forming device 3 is registered as the coordinates 103d of the photographing device 4. The coordinates 103b of the image forming device 3 and the coordinates 103d of the photographing device 4 are shown in an XYZ coordinate system. The coordinates in the XY direction shows the coordinates in a horizontal direction in each room and the coordinates in the Z direction shows a height direction in each room. The location relation information 103 does not always have to show the relation between the locations of the image forming device 3 and the photographing device 4. The location relation information 103 may be the information that identifies the relation between the locations of the image forming device 3 and the photographing device 4 in the coordinates system. The location relation information 103 may be information showing the relation between the locations of the image forming device 3 and the photographing device 4 with an angle and a distance. The location relation information 103 may be information integrated with the related information 102.

The photographing controller 453 refers to the coordinates 103b of the image forming device 3 and the coordinates 103d of the photographing device 4 in the location relation information 103 to determine the photographing direction of the photographing unit 42. More specifically, the photographing controller 453 calculates the difference between the coordinates 103b of the image forming device 3 that processed the print job and the coordinates 103d of the photographing device 4 in which the photographing controller 453 itself is included. The photographing controller 453 determines the photographing direction of the photographing unit 42 based on the calculated difference. When the determined photographing direction and the current photographing direction of photographing device 4 in which the photographing controller 453 itself is included has a difference, the photographing controller 453 controls the photographing direction adjusting unit 43 to adjust to the determined photographing direction in which the photographing unit 42 is photographing. The photographing controller 453 controls the photographing direction adjusting unit 43 to adjust the photographing direction of the photographing unit 42 so that the image forming device 3 that processed the print job may be settled within the range of photographing by the photographing unit 42. In order to photograph the image that includes the image forming device 3 that processed the print job and a landscape around the image forming device 3, the photographing controller 453 is also enabled to adjust the focal distance and/or the magnification of the photographing lens of the photographing unit 42. The photographed image including the image forming device 3 that processed the print job and the landscape around the image forming device 3 is photographed so that the user can easily identify the location of the image forming device 3 to which he or she sent the print job. After controlling the photographing direction adjusting unit 43 to adjust the photographing direction, the photographing controller 453 enables the photographing unit 42 to start photographing. After enabling the photographing unit 42 to start photographing, the photographing controller 453 outputs the photographed image 7 to the image transmitter 454 and the image detector 455. The photographing controller 453 stores information showing the photographing direction, for instance, in the storage 44 or the memory which is not shown in any figure for every adjustment of the photographing direction of the photographing unit 42.

The image transmitter 454 sends the image photographed by the photographing unit 42 to the information processing device 2 used by the user. In response to inputting the photographed image 7, the image transmitter 454 refers to the destination information 104 stored in the storage 44 and determines the information processing device 2 to send the photographed image 7 to. The image transmitter 454 starts sending the photographed image 7 to the determined information processing device 2.

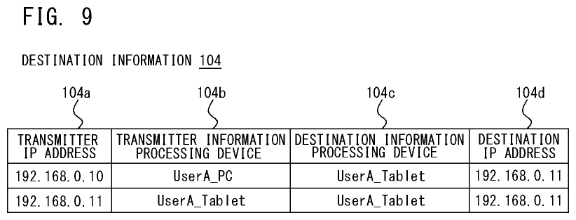

FIG. 9 illustrates an example of the destination information 104. As illustrated in FIG. 9, an IP address 104a of the information processing device 2 which is the transmitter of the job, a name 104b of the information processing device 2 which is the transmitter of the job, a name 104c of the information processing device 2 that is the destination of the photographed image 7 and an IP address 104d of the information processing device 2 that is the destination of the photographed image 7 corresponding to each other is defined in the destination information 104. The destination information 104 is set in advance by the user, for example, and stored in the storage 44. The image transmitter 454 refers to the destination information 104 and identifies the information processing device 2 that sent the print job based on the device information such as the IP address of the information processing device 2 obtained by the information obtaining unit 451. It is assumed, for example, that the device information of the information processing device 2 obtained by the information obtaining unit 451 shows an IP address “192.168.0.10.” In this case, the image transmitter 454 confirms the transmitter IP address 104a corresponding to “192.168.0.10.” The image transmitter 454 refers to the name 104b of the information processing device 2 which is the transmitter corresponding to the transmitter IP address 104a which is “192.168.0.10.” The image transmitter 454 then confirms that the name of the information processing device 2 that is the transmitter and has the IP address of “192.168.0.10” is “UserA_PC.” Thus, the image transmitter 454 is enabled to identify the information processing device 2 that sent the print job is “UserA_PC.”

After identifying the information processing device 2 which is the transmitter of the print job, the image transmitter 454 refers to the name 104c of the destination information processing device 2 of the photographed image 7 and the IP address (destination IP address) 104d of the destination information processing device 2 included in the destination information 104 to confirm the name and the IP address of the information processing device 2 to be the destination of the photographed image 7. It is assumed, for example, the name of the information processing device 2 that sent the print job is “UserA_PC.” In this case, the image transmitter 454 confirms the name of the information processing device 2 to be the destination of the photographed image 7 is “UserA_Tablet” and the IP address of the information processing device 2 is “192.168.0.11.”

Upon identifying the information processing device 2 to be the destination of the photographed image 7 (in the example of FIG. 9, “UserA_Tablet”), the image transmitter 454 starts sending the photographed image 7 to the identified information processing device 2. The image transmitter 454 may also obtain information in the related information 102 such as the room number of the room in which the image forming device 3 is located as the location information indicating the location of the image forming device 3 and add an image showing the location information to the photographed image 7. When the information processing device 2 receives and displays the photographed image 7 on the display unit, the location information added to the photographed image 7 is also displayed with the photographed image 7 as the information showing the location of the image forming device 3. The user is enabled not only to check the image forming device 3 itself and the landscape around the image forming device 3 in the photographed image 7 but also the location information such as the room number. This makes easier for the user to find the location of the image forming device 3. After receiving the aforementioned ending instruction from the information processing device 2 or the image forming device 3, the image transmitter 454 completes sending the photographed image 7.

For sending the photographed image 7 to the information processing device 2, the image transmitter 454 may send the photographed image 7 as it is or create a web page that enables a display of the photographed image 7 on the information processing device 2 and send a URL (Uniform Resource Locator) of the created webpage to the information processing device 2.

The image transmitter 454 does not always have to determine the information processing device 2 to be the destination of the photographed image 7 based on the destination information 104. The image transmitter 454, for example, may determine the information processing device 2 which is the transmitter of the print job as the destination of the photographed image 7. In such a case, the image transmitter 454 sends the photographed image 7 to the IP address of the information processing device 2 which is the transmitter of the print job included in the device information without referring to the destination information 104.

The image detector 455 detects a device image of the image forming device 3 and/or a person image around the device image included in the photographed image 7. After the photographing unit 42 starts photographing the image forming device 3, the image detector 455 becomes operative. The image detector 455 analyzes the photographed image 7, and detects the device image and/or the person image around the device image in the photographed image 7. The image detector 455, for example, analyzes the image by pattern matching, for instance, and detects the device image and/or the person image in the photographed image 7. The device image and/or the person image included in the photographed image 7 thereby detected does not have to be one. If more than one device image and/or the person image is included in the photographed image 7, the image detector 455 detects every device image and/or the person image. After detecting the device image and/or the person image around the device image included in the photographed image 7, the image detector 455 outputs information indicating a location of the detected image in the photographed image 7 to the device image identifying unit 456 and the highlighting unit 457.

The device image identifying unit 456 identifies the device image of the image forming device 3 that processed the print job included in the photographed image 7. If the multiple device images are included in the photographed image 7, the user cannot figure out which of the multiple device images corresponds to the image forming device 3 that processed the print job. The device image identifying unit 456 identifies the device image of the image forming device 3 that processed the print job when the multiple device images are detected by the image detector 455. When only the single device image is detected by the image detector 455, the device image identifying unit 456 identifies that the single detected device image corresponds to the image forming device 3 that processed the print job.

When multiple device images are detected by the image detector 455, the device image identifying unit 456 identifies the device image corresponding to the image forming device 3 that processed the print job among from the multiple device images. The location relation information 103 stored in the storage 44 is used as device image information to identify the device image of the image forming device 3 that processed the print job among from the multiple device images. The device image identifying unit 456, for instance, refers to the coordinates 103d of the photographing device 4, in which itself is included, in the location relation information 103 to confirm the coordinates of the photographing device 4 in which itself is included. The device image identifying unit 456 then refers to the coordinates 103b of the image forming device 3 that processed the print job in the location relation information 103.

The device image identifying unit 456 compares the range of photographing by the photographing unit 42 with the coordinates 103b of the image forming device 3 that processed the print job, and calculates the position in the photographed image 7 of the device image of the image forming device 3 that processed the print job. The device image identifying unit 456 identifies the nearest device image to the calculated position as the device image corresponds to the image forming device that processed the print job. After identifying the device image for the image forming device 3 that processed the print job, the device image identifying unit 456 outputs the information indicating the position of the device image in the photographed image 7 to the highlighting unit 457.

The highlighting unit 457 highlights the device image and/or the person image around the device image in the photographed image 7. Upon inputting the information relating to the position of the device image and/or the person image around the device image in the photographed image 7 from the image detector 455, the highlighting unit 457 confirms the position of the device image and/or the person image around the device image in the photographed image based on the input information. In response to inputting the information indicating the position of the device image that corresponds to the image forming device 3 that processed the print job from the device image identifying unit 456, the highlighting unit 457 confirms the position of the device image in the photographed image 7 based on the input information. The highlighting unit 457 highlights (marks) the device image of the image forming device 3 that processed the print job and/or the person image around the device image. The highlighting unit 457 highlights the image by, for example, framing around the image, using effect line around the image or adding an arrow to point the image. The device image of the image forming device 3 that processed the print job and/or the person image around the device image in the photographed image 7 is highlighted so that the user is allowed to easily see the device image and/or the person image around the device image. Even when multiple device images are included in the photographed image 7, the device image of the image forming device 3 that processed the print job is highlighted so that the user is allowed to easily identify the device image of the image forming device 3 that processed the print job among from the multiple device images. Not only the device image included in the photographed image 7 is highlighted but also the person image around the device image is highlighted. The user may be informed that the printed output may be obtained by someone who is around the image forming device 3 if the person is around the image forming device 3.

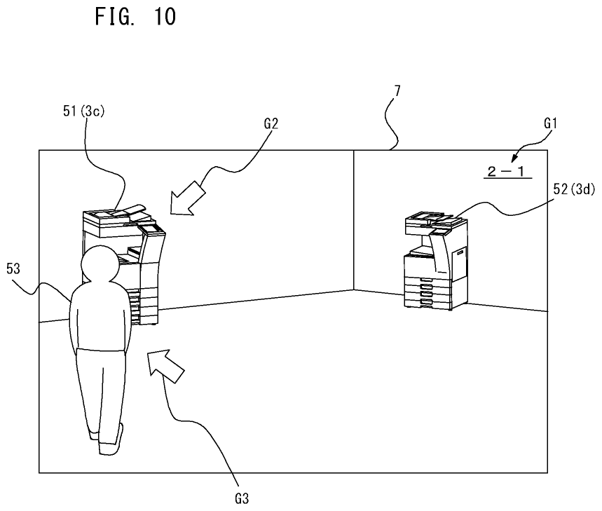

FIG. 10 illustrates an example of the photographed image 7 sent to the information processing device 2 by the image transmitter 454. As illustrated in FIG. 10, a device image 51 (3c), a device image 52 (3d) and a person image 53 are shown in the photographed image 7. The device image 51 (3c) corresponds to the image forming device 3c and the device image 52 (3d) corresponds to the image forming device 3d. When the image forming device identifying unit 452 identifies the image forming device 3c as the device processed the print job, the photographing device 4 photographs the photographed image 7 as illustrated in FIG. 10. An image G1 is the location information indicating the room number of the room in which the image forming device 3c that processed the print job is located as illustrated in FIG. 10. The image G1 is added to the photographed image 7 by the image transmitter 454. The user sees the added image G1 so that he or she may find out the room number of the room, in which the image forming device 3c that processed the print job is located. The device image 51 (3c) and the person image 53 are highlighted with highlighting images G2 and G3. The user may easily see the device image 51 (3c) and the person image 53. The device image 51 (3c) is highlighted with the highlighting image G2. It is not only for the user to see the device image 51 (3c) easily but also is allowed to find out the device image 51 (3c) corresponds to the image forming device 3c that processed the print job among from the device images 51 (3c) and 52 (3d).

The map information editor 458 edits the map information 105 (105a and 105b) stored in the storage 44 and generates the map information 105 showing the location of the image forming device 3 identified by the image forming device identifying unit 452. The map information 105 is used as the location information that indicates the room in which the image forming device 3 is located or the location information indicating the location of the image forming device 3 in each room.

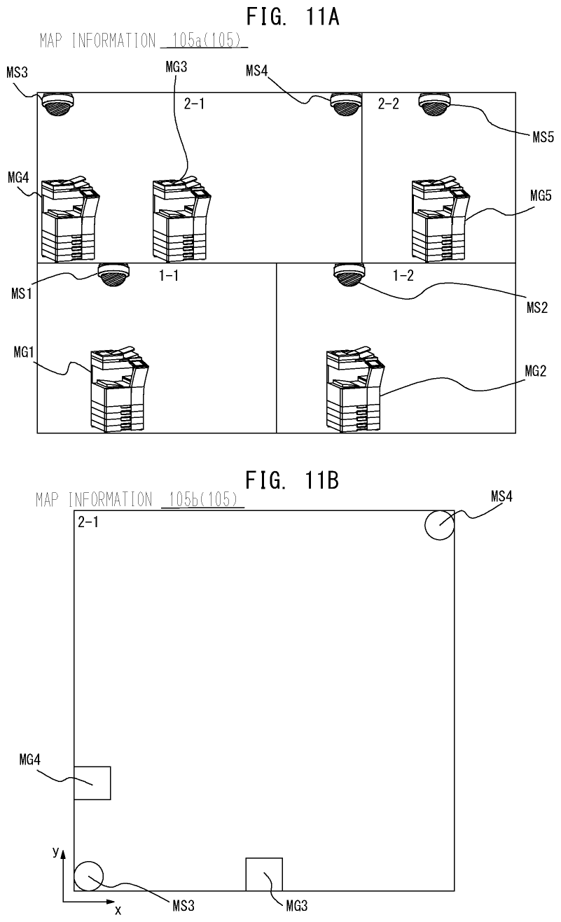

FIGS. 11 A and 11B illustrate an example of the map information 105 (105a and 105b) prior to edition stored in the storage 44. FIG. 11A illustrates an example of the map information 105a showing the location of the image forming device 3 in the office. As illustrated in FIG. 11A, the map information 105a shows the location of the image forming device 3 and the photographed device 4 in the office. Images MG1 to MG5 showing the locations of the respective image forming devices 3a to 3e and images MS1 to MS5 showing the respective positions of the photographing devices 4a to 4e are shown in the map information 105a. FIG. 11B illustrates an example of the map information 105b showing the location of the image forming device 3 in each room in which the image forming device 3 is located. Images showing the locations of the image forming device 3 and the photographing device 4 are included in a plain figure of the room shown by coordinates in the XY direction as illustrated in FIG. 11B. The map information 105b is generated in advance for each room in which the image forming device 3 is located. The generated map information 105b is stored in the storage 44. The map information 105b of FIG. 11B corresponds to the room 2-1. The images MG3 and MG4 showing the locations of the image forming devices 3 and the image MS3 and MS4 showing the positions of the photographing devices 4 are shown in the plain diagram of the room 2-1 in the map information 105b. The map information 105 may be information such as a network map showing a structure of the devices connected to the network 6.

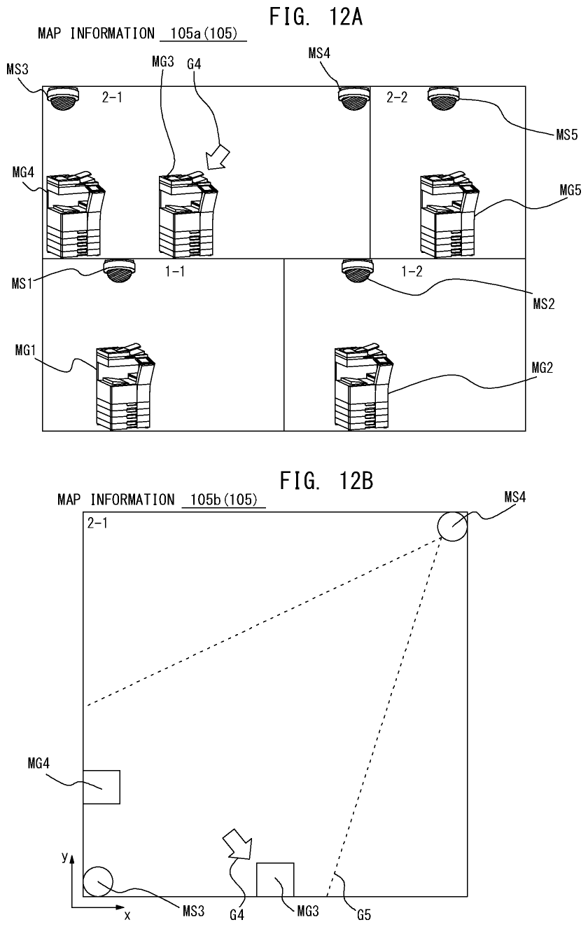

The map information editor 458 edits the map information 105 as described above, and generates the information indicating the location of the image forming device 3 (the image forming device that processed the print job) identified by the image forming device identifying unit 452. FIGS. 12A and 12B illustrate an example of the map information 105 generated by the map information editor 458. FIG. 12A illustrates an example of the map information 105a showing the location of the image forming device 3 that processed the print job in the office. In the example of FIG. 12A, the image MG3 showing the location of the image forming device 3 that processed the print job is highlighted with an image G4. The highlighting unit 457 displays the image G4 around the image MG3 to highlight the image MG3. The user sees the image MG3 highlighted with the image G4, and he or she is allowed to easily determine the MG3 corresponds to the image that shows the location of the image forming device 3 that processed the print job. As described above, the user sees the map information 105a, and is allowed to easily find out that the image forming device 3 that processed the print job is located in the room 2-1.

FIG. 12B illustrates an example of the map information 105b showing the location of the image forming device 3 in the room in which the image forming device 3 that processed the print job is located. The map information 105b shows the location of the image forming device 3 in the room in which the image forming device 3 that processed the print job is located. As the same as the example of FIG. 12A, the image G4 is displayed around the image MG3 so that the image MG3 is highlighted. As a result, the user is allowed to easily determine the MG3 corresponds to the image that shows the location of the image forming device 3 that processed the print job. In the example of FIG. 12B, an image G5 is added. The image G5 shows the direction in which the photographing device 4 is photographing the image forming device 3. The image G5 is added so that the user is allowed to find out that the image MS4 corresponds to the location of the photographing device 4 that is photographing the image forming device 3. Also, the image G5 showing the photographing direction enables the user to figure out the photographed image 7 is photographed from which direction. As described above, the map information editor 458 edits the map information 105 to add the images G4 and G5, and generates the map information 105 including the image to highlight the device image of the image forming device 3 that processed the print job. The map information editor 458 then outputs the generated map information 105 to the image transmitter 454. In response to inputting the map information 105 generated by the map information editor 458, the image transmitter 454 sends the input map information 105 to the information processing device 2 together with the photographed image 7.

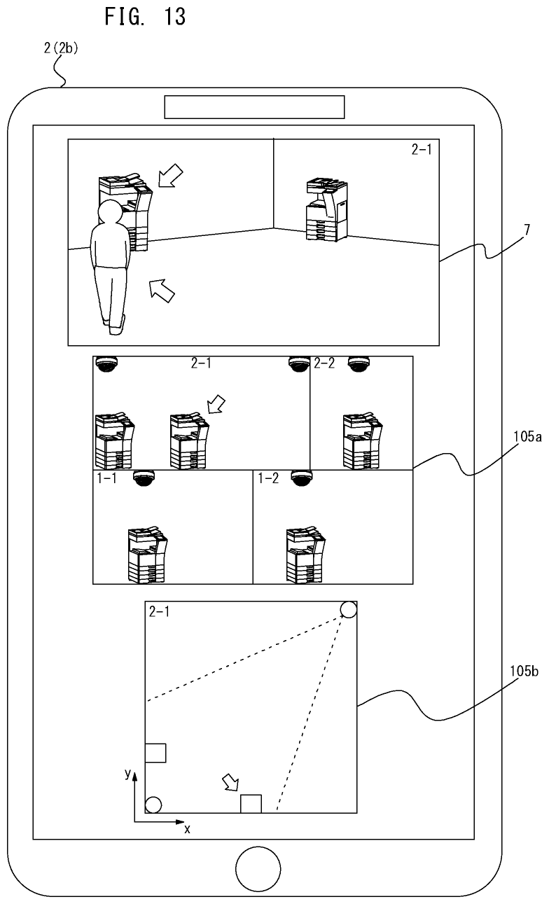

FIG. 13 illustrates an example of the photographed image 7 displayed on the display unit of the information processing device 2. In the example of FIG. 13, the photographed image 7, the map information 105a and 105b generated by the map information editor 458 is displayed on the display unit of the information processing device 2. The user who sent the print job sees the photographed image 7 and the map information 105a and 105b generated by the map information editor 458 displayed on the display unit of the information processing device 2, and he or she is allowed to identify the location of the image forming device 3 that processed the print job sent by him or her.

As described above, the photographing device 4 of one or more embodiments obtains the device information of the information processing device 2 which is the transmitter of the print job from the image forming device 3. The photographing device 4 refers to the IP header received together with the device information from the image forming device 3, and obtains the identification information that identifies the image forming device 3. After identifying the image forming device 3 that processed the job, the photographing device 4 photographs the image that enables to identify the location of the image forming device 3. The photographing device 4 is enabled to send the photographed image 7 to the information processing device 2 used by the user to send the print job. The information processing device 2 displays the photographed image 7 received from the photographing device 4 on the predetermined display unit. The user sees the information including the photographed image 7 displayed on the display unit of the information processing device 2, and figures out the location of the image forming device 3 to which he or she sent the print job.

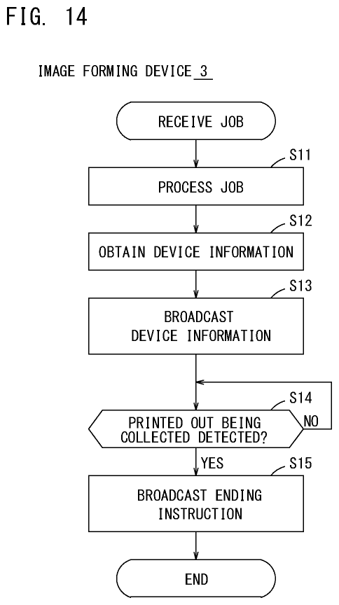

A detailed process sequence performed in the image forming device 3 is explained next. FIG. 14 illustrates a flow diagram explaining an exemplary procedure of a main process performed by the image forming device 3. This process is performed when the image forming device 3 receives the print job. Upon the start of the process, the image processing device 3 processes the received print job (step S11). The image forming device 3 produces the printed output based on the print job. The image forming device 3 obtains the device information of the information processing device 2 which is the transmitter of the print job (step S12). To be more specific, the image forming device 3 obtains the address information such as the IP address of the information processing device 2 which is the transmitter of the print job from the header of the print job as the device information. After obtaining the device information of the information processing device 2, the image forming device 3 broadcasts the obtained device information to all devices connected to the network 6 (step S13). The device information of the information processing device 2 is broadcasted so that the photographing device 4 is enabled to obtain the device information of the information processing device 2. After obtaining the device information, the photographing device 4 that is enabled to photograph the image forming device 3 that processed the print job starts photographing the image that enables to identify the location of the image forming device 3 that processed the print job. The photographing device 4 then sends the photographed image 7 to the information processing device 2 used by the user. The image forming device 3 checks if the printed output is collected by the user (step S14). To be more specific, the image forming device 3 checks if the printed output is collected by determining if the printed output detecting sensor 36 has detected the printed output. As a result of the check, the printed output may not be collected (when a result of step S14 is NO). In this case, the image forming device 3 waits until the printed output is collected. When the printed output has already been collected (when a result of step S14 is YES), the image forming device 3 broadcasts the ending instruction (step S15), and completes the process. In response to receiving the ending instruction broadcasted from the image forming device 3, the photographing device 4 completes the photographing of the photographed image 7 to display on the information processing device 2 and completes sending the photographed image 7 to the information processing device 2.

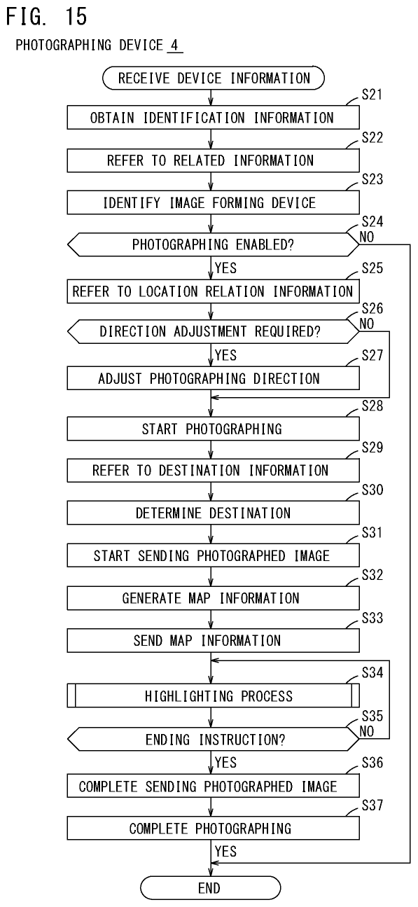

A detailed process sequence performed in the photographing device 4 is explained next. FIG. 15 illustrates a flow diagram explaining an exemplary procedure of a main process performed by the photographing device 4. This process is performed when the photographing device 4 receives the device information of the information processing device 2. Upon the start of the process, the photographing device 4 obtains the identification information for identifying the image processing device 3 that sent the device information of the information processing device 2 (step S21). To be more specific, the photographing device 4 refers to the IP header received from the image forming device 3 together with the device information, and obtains the address information such as the IP address of the image forming device 3 as the identification information. After obtaining the identification information of the image forming device 3, the photographing device 4 refers to the related information 102 in the storage 44 (step S22). The photographing device 4 identifies the image forming device 3 that processed the print job based on the identification information and the related information 102 (step S23). The photographing device 4 determines if it is enabled to photograph the identified image forming device 3 (step S24). When the photographing device 4 is not enabled to photograph the identified image forming device 3 (when a result of step S24 is NO), it completes the process. The photographing device 4 may be enabled to photograph the identified image forming device 3 (when a result of step S24 is YES). In such a case, the photographing device 4 refers to the location relation information 103 stored in the storage 44 (step S25).

The photographing device 4 refers to the location relation information 103 (step S25), and determines the photographing direction based on the locations of the identified image forming device 3 and itself. The photographing device 4 confirms if the determined photographing direction and the direction in which the photographing device 4 photographs are different from each other to determine if it is necessary to adjust the photographing direction (step S26). If the adjustment in the photographing direction is unnecessary (when a result of step S26 is NO), the photographing device 4 moves on to the process in step S28. When the adjustment in the photographing direction is necessary (when a result of step S26 is YES), the photographing device 4 adjusts the photographing direction (step S27). The photographing device 4 then starts photographing the identified image forming device 3 (step S28). Upon starting photographing the identified image forming device 3, the photographing device 4 refers to the destination information 104 stored in the storage 44 (step S29). The photographing device 4 determines the information processing device 2 to be the destination of the photographed image 7 based on the device information such as the IP address of the information processing device 2 and the destination information 104 (step S30). After determining the information processing device 2 to be the destination, the photographing device 4 starts sending the photographed image 7 to the information processing device 2 (step S31). The photographing device 4 generates the map information 105 showing the location of the image forming device 3 that processed the print job (step S32). To be more specific, the photographing device 4 edits the map information 105 in the storage 44 to add the image indicating the location of the image forming device 3 that processed the print job. The photographing device 4 then generates the map information 105 to inform the user of the location of the image forming device 3 that processed the print job. After generating the map information 105 showing the location of the identified image forming device 3, the photographing device 4 sends the generated map information 105 to the information processing device 2 (step S33).

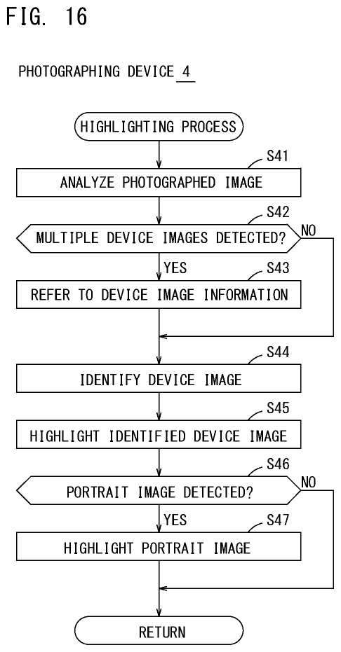

The photographing device 4 performs a highlighting process to highlight the device image and/or the person image included in the photographed image 7 (step S34). FIG. 16 illustrates a flow diagram explaining an exemplary procedure of the highlighting process (step S34) in detail. Upon the start of the process, the photographing device 4 analyzes the photographed image 7 and detects the device image and/or the person image around the device image included in the photographed image 7 (step S41). More specifically, the photographing device 4 performs the image analysis such as the pattern matching, and detects all the device image and/or the person image around the device image included in the photographed image 7. The photographing device 4 confirms if the multiple device images are detected (step S42). If the multiple device images are not detected (when a result of step S42 is NO), the photographing device 4 moves on to the process in step S44. If the multiple device images are detected (when a result of step S42 is YES), the photographing device 4 reads and refers to device image information such as the location relation information 103 (step S43). As described above, the device image information is to identify the device image of the image processing device 3 that processed the print job. The photographing device 4 identifies the device image of the image forming device 3 that processed the print job among from the multiple device images based on the location relation information 103 stored in the storage 44 and the information of the current direction in which it photographs (step S44). When the multiple device images are not detected (when a result of step S42 is NO), the photographing device 4 also identifies the single device image included in the photographed image 7 as the device image corresponding to the image forming device 3 that processed the print job (step S44). The photographing device 4 highlights the device image of the identified image forming device 3 (step S45). The device image is highlighted so that the user is allowed to easily find the device image of the image forming device 3 that processed the print job. The photographing device 4 determines if the person image is detected around the identified device image (step S46). When no person image is detected (when a result of step S46 is NO), the photographing device 4 completes the highlighting process. When the person image is detected (when a result of step S46 is YES), the photographing device 4 highlights the person image (step S47), and completes the highlighting process. In one or more embodiments, the photographed image 7 sent to the information processing device 2 from the photographing device 4 is the moving image. The person image in the moving image may be moved. The photographing device 4 repeatedly performs the highlighting process of the photographed image 7 until receiving the ending instruction.

Referring back to FIG. 15, after the highlighting process, the photographing device 4 determines if the ending instruction is received from the information processing device 2 or the image forming device 3 (step S35). When the ending instruction is not received (when a result of step S35 is NO), the photographing device 4 moves back to the process in step S34. In response to receiving the ending instruction (when a result of step S35 is YES), the photographing device 4 completes sending the photographed image 7 (step S36). The photographing device 4 completes photographing the image forming device 3 (step S37), and completes the process.

As described above the image forming system 1 of one or more embodiments enables the image forming device 3 that processed the print job to obtain the device information of the information processing device 2 that is the transmitter of the print job and broadcast the obtained device information. The photographing device 4 that is one of the multiple photographing devices 4 received the device information of the information processing device 2 and is enabled to photograph the image forming device 3 received the print job photographs the image that enables the user to identify the location of the image forming device 3. The photographed image 7 is then sent to the information processing device 2 used by the user. As described above, the user sees the photographed image 7 displayed on the information processing device 2 so that he or she is allowed to find out the location of the image forming device 3 that processed the print job sent by the user. Also, it is not necessary for the image forming device 3 of one or more embodiments to store therein in advance the image that enables to identify the location of itself.

One or more embodiment of the present invention will be explained next. The image forming device 3 of the above-described embodiments broadcasts the device information of the information processing device 2 to enable the photographing device 4 to obtain the device information of the information processing device 2. The image forming device 3 of one or more embodiments identifies the photographing device 4 that is enabled to photograph itself among from the multiple photographing devices 4 and sends the device information of the information processing device 2 to the identified photographing device 4 in unicast communication.

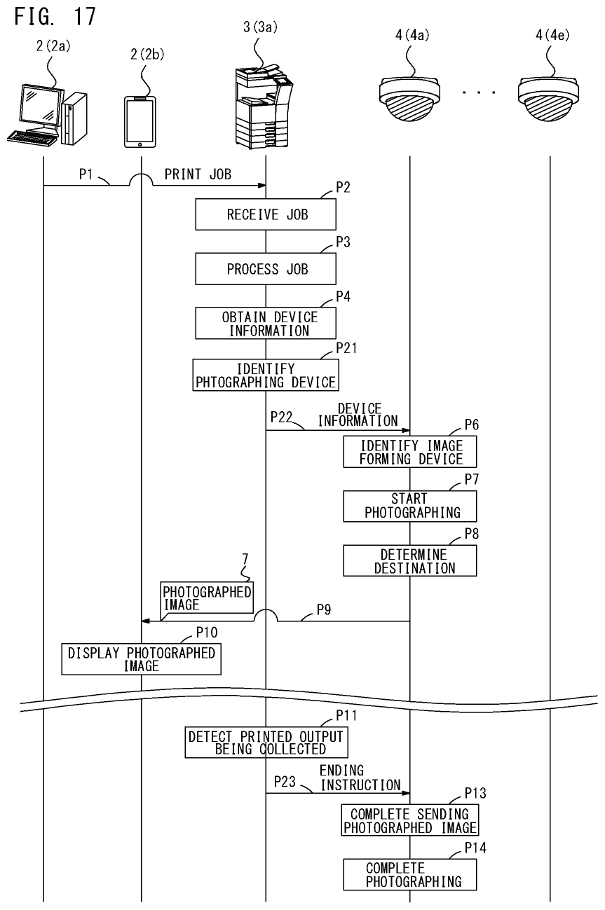

FIG. 17 is a flow diagram showing an exemplary operation performed when the image forming system 1 of one or more embodiments informs the user of the location of the image forming device 3. The process in process P1 to P4, P6 to P11, P13 and P14 of FIG. 17 is the same as the process in process P1 to 4, P6 to 11, P13 and P14 of FIG. 3. The process is not explained again. After obtaining the device information of the information processing device 2a from the header of the print job (process P4), the image forming device 3a that processed the print job identifies the photographing device 4 that is enabled to photograph the image forming device 3a (process P21). The image forming device 3a refers to the related information 102, and identifies the photographing device 4 that is enabled to photograph the image forming device 3a. In the example of FIG. 17, the photographing device 4a is identified as the photographing device 4 that is enabled to photograph the image forming device 3a. The image forming device 3a sends the device information of the information processing device 2a to the identified photographing device 4a (process P22). After obtaining the device information of the information processing device 2a, the photographing device 4a identifies the image forming device 3a that processed the print job (process P6), and starts photographing the image that enables the user to identify the location of the image forming device 3a (process P7). The photographing device 4a then determines the information processing device 2 to send the photographed image 7 (process P8). In the example of FIG. 17, the information processing device 2b is determined as the destination of the photographed image 7. The photographing device 4a starts sending the photographed image 7 to the information processing device 2b (process P9). Upon receiving the photographed image 7, the information processing device 2b displays the received photographed image 7 on the display unit (process P10). The user sees the photographed image 7 displayed on the display unit of the information processing device 2b so that he or she is allowed to find out the location of the image forming device 3a that processed the print job, which is the same as the above embodiments. When the image forming device 3a detects that the printed output is collected (process P11), it sends the ending instruction to the photographing device 4a (process P23). The image forming device 3a does not broadcast the ending instruction, and sends the ending instruction to the photographing device 4a in unicast communication. In response receiving the ending instruction from the image forming device 3a, the photographing device 4a completes sending the photographed image 7 and photographing the image forming device 3a (process P13 and P14).

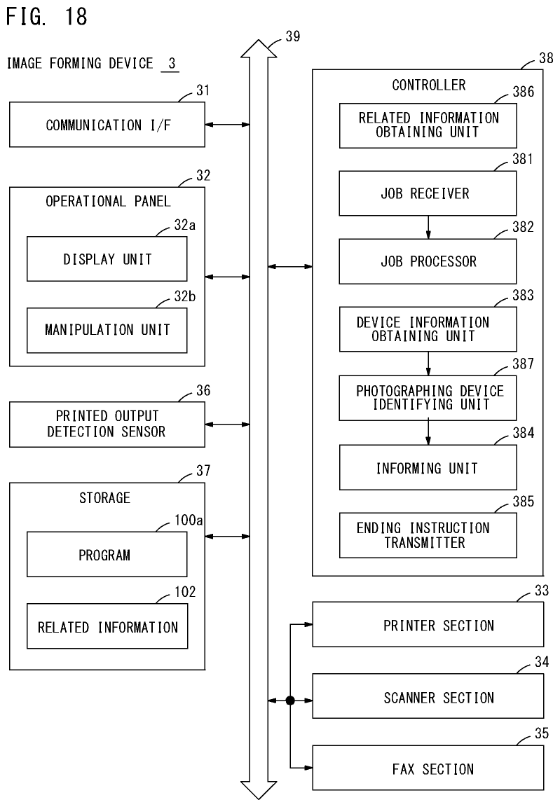

The detailed structure and operations of the image forming device 3 of one or more embodiments are explained next. FIG. 18 illustrates a block diagram showing an example of the hardware structure and the functional structure of the image forming device 3 of one or more embodiments. The hardware structure of the image forming device 3 of one or more embodiments is the same as that explained in the above embodiments so is not explained.

A program 100a and the related information 102 are stored in the storage 37 of one or more embodiments, for example. The related information 102 is used when the image forming device 3 identifies the photographing device 4 that is enabled to photograph the image forming device 3. Address information such as an IP address of the photographing device 4 corresponding to the name of the photographing device 102d that is enabled to photograph is further added to the related information 102 of one or more embodiments and stored as the related information 102 of one or more embodiments.

The CPU of the controller 38 of one or more embodiments reads and executes the program 100a. The controller 38 then serves as a related information obtaining unit 386, the job receiver 381, the job processor 382, the device information obtaining unit 383, a photographing device identifying unit 387, the informing unit 384 and the ending instruction transmitter 385. Each of these parts is described in detail below.

The related information obtaining unit 386 obtains the related information in which the photographing device 4 enabled to photograph the image forming device 3 in which itself is included is defined. The related information obtaining unit 386 obtains the related information 102 from the server not shown in FIG. 18 connected to the network 6, for example, and stores the obtained related information 102 in the storage 37.

The job receiver 381, the job processor 382 and the device information obtaining unit 383 are the same as those explained in the above embodiments.

The photographing device identifying unit 387 identifies the photographing device 4 that is enabled to photograph the image forming device 3 in which itself is included. The photographing device identifying unit 387 reads the related information 102 in the storage 37 and refers to the name of the photographing device 102d that is enabled to photograph. The photographing device identifying unit 387 then identifies the photographing device 4 that is enabled to photograph the image forming device 3 in which itself is included. There may be more than one photographing device 4 that is enabled to photograph the image forming device 3 in which itself is included. In such a case, the photographing device identifying unit 387 identifies the more than one photographing device 4. The photographing device identifying unit 387 obtains the address information such as the IP address corresponding to the identified photographing device 4 based on the related information 102. The photographing device identifying unit 387 outputs the obtained address information of the photographing device 4 to the informing unit 384. The photographing device identifying unit 387 of one or more embodiments identifies the more than one photographing device 4 when there is more than one photographing device 4 that is enabled to photograph the image forming device 3 in which itself is included. However, this is given not for limitation. The photographing device identifying unit 387 may identify one of the more than one photographing device 4 that is enabled to photograph the image forming device 3 in which itself is included.

The informing unit 384 of one or more embodiments sends the device information of the information processing device 2 to the photographing device 4 identified by the photographing device identifying unit 387. In response to inputting the address information of the photographing device 4 identified by the photographing device identifying unit 387, the informing unit 384 sends the device information of the information processing device 2 to the photographing device 4. The photographing device 4 that is enabled to photograph the image forming device 3 is identified and the device information is sent to the identified photographing device 4 in unicast communication. Compared to the above embodiments in which the device information is broadcasted, the communication load on the network 6 may be reduced in one or more embodiments. It is also unnecessary to determine if the photographing device 4 received the device information of the information processing device 2 is enabled to photograph the image forming device 3 processed the print job.

The ending instruction transmitter 385 is the same as those explained in the above embodiments.

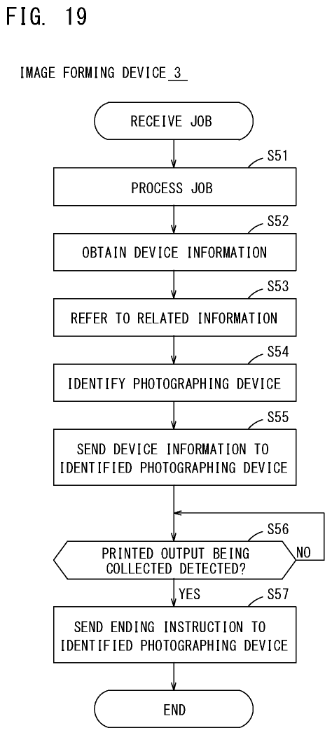

A detailed process sequence performed in the image forming device 3 of one or more embodiments is explained next. FIG. 19 illustrates a flow diagram explaining an exemplary procedure of a main process performed by the image forming device 3 of one or more embodiments. This process is performed when the image forming device 3 receives the print job. Upon the start of the process, the image processing device 3 processes the received print job (step S51). The image forming device 3 obtains the device information of the information processing device 2 which is the transmitter of the print job from the header of the print job (step S52). The image forming device 3 refers to the related information 102 (step S53) to identify the photographing device 4 that is enabled to photograph itself (step S54). The image forming device 3 sends the device information of the information processing device 2 to the identified photographing device 4 in unicast communication (step S55). After receiving the device information, the photographing device 4 starts photographing the image that enables to identify the location of the image forming device 3 that processed the print job, and sends the photographed image 7 to the information processing device 2 used by the user. The image forming device 3 checks if the printed output is collected by the user (step S56). As a result of the check, the printed output may not be collected (when a result of step S56 is NO). In this case, the image forming device 3 waits until the printed output is collected. When the printed output has already been collected (when a result of step S56 is YES), the image forming device 3 sends the ending instruction to the identified photographing device 4 in unicast communication (step S57), and completes the process.

As described above, the image forming system 1 of one or more embodiments enables the image forming device 3 that processed the print job to obtain the device information of the information processing device 2, the transmitter of the print job, and identify the photographing device 4 that is enabled to photograph itself. The image forming device 3 then sends the device information of the information processing device 2, the transmitter of the print job to the identified photographing device 4 in unicast communication. In response to obtaining the device information of the information processing device 2, the photographing device 4 starts photographing the image that enables the user to identify the location of the image forming device 3 that processed the print job. The photographing device 4 is enabled to send the photographed image 7 to the information processing device 2 used by the user. As described above, the image forming device 3 does not broadcast the device information of the information processing device 2, resulting in reduction of the communication load on the network 6. The image forming device 3 only sends the device information of the information processing device 2 to the photographing device 4 that is enabled to photograph the image forming device 3 that processed the print job. It is not necessary to conduct the determination if the photographing device 4 is enabled to photograph the image forming device 3 that processed the print job.

Although the embodiments of the present invention has been described and illustrated in detail, it is clearly understood that the same is by way of illustration and example only and not limitation, the scope of the present invention should be interpreted by terms of the appended claims.

### (Modifications)

While the embodiments of the present invention have been described above, the present invention is not limited to the above embodiments. Various modifications may be applied to one or more embodiments of the present invention.

In the above-described embodiments, for example, the user is informed of the location of the image forming device 3 that processed the print job received from the user no matter which image forming device 3 of the multiple image forming devices 3 processed the print job. However, this is given not for limitation. The image forming system 1, for example, may store history information in the image forming device 3 or the photographing device 4. The number of the print jobs sent to each image forming device 3 is recorded for each user and registered as the history information. When the print job to the image forming device 3 is sent, the image forming system 1 checks the number of the print job sent by the user to the same image forming device 3 based on the history information in the image forming device 3 or the photographing device 4. As a result of the check, the number of the print job sent by the user to the image forming device 3 may be equal to or more than a predetermined number. In such a case, the image forming system 1 may not inform the user of the location of the image forming device 3. Since the user has sent the print job to the image forming device 3 for equal to or more than the predetermined number, it is considered that the user is familiar with the location of the image forming device 3. As a result, the image forming system 1 does not have to send the photographed image 7 that shows the location of the image forming device 3 to the information processing device 2 as the location of the image forming device 3 has already been known by the user. The image forming device 3 usually used by the user may be registered for each user in advance. When the print job is sent to the image forming device 3 that is not registered, the image forming system 1 may inform the user of the location of the image forming device 3.

In the above-described embodiments, the photographing device 4 is arranged on a ceiling of the room in which the image forming device 3 is located. However, this is given not for limitation. The photographing device 4, for instance, may be incorporated in the image forming device 3. When the photographing device 4 is incorporated in the image forming device 3, the image forming device 3 that received the print job may only send the device information of the information processing device 2, the transmitter of the print job, to the photographing device 4 which is incorporated in the image forming device 3. If the photographing device 4 is incorporated in the image forming device 3, the image forming device 3 is not necessary to broadcast the device information of the information processing device 2, the transmitter of the print job, to all devices connected to the network 6 or send to the photographing device 4 in unicast communication after identifying the photographing device 4 that is enabled to photograph the image forming device 3.

The image forming device 3 of the above-described embodiments is constructed by a device such as the MFP including multiple functions such as the scan function, the print function, the copy function and the fax function. The image forming device 3 does not have to be the device such as one of MFPs including the multiple functions such as the scan function, the print function, the copy function and the fax function. The image forming device 3 should be a device at least including the print function.

In the above-described embodiments, the program such as the program 100 is installed in advance in the image forming device 3. The program such as the program 100 does not always have to be installed in advance in the image forming device 3. The program 100 may be the one that can be the object for trading with itself. In this case, the program 100 may be provided over an internet in a manner that enables a user to download, or may be provided with the image forming device 3 in a manner that is recorded on a computer readable recording medium such as a CD-ROM or a USB memory.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming system comprising:
a first image forming device that produces a printed output based on a print job sent by an information processing device; and
a first photographing device arranged at a position in which a photographing of the first image forming device is enabled, wherein
the first image forming device and the first photographing device communicate with each other over a network,
the first image forming device comprises a hardware processor that:
obtains device information that identifies the information processing device that has sent the print job; and
sends the device information to the first photographing device upon receiving the print job,
the first photographing device comprises:
an imaging device that photographs an image that identifies a location of the first image forming device; and
a hardware processor that sends the image photographed by the imaging device to the information processing device based on the device information upon receiving the device information from the first image forming device.

2. The image forming system according to claim 1, wherein
the imaging device photographs the image including the first image forming device and a landscape around the first image forming device.

3. The image forming system according to claim 1, wherein
the hardware processor of the first photographing device further:
obtains location information that shows the location of the first image forming device and is different from the image photographed by the imaging device, and
sends the location information and the image to the information processing device.

4. The image forming system according to claim 3, wherein
the hardware processor of the first photographing device obtains map information as the location information, and
the map information shows the location of the first image forming device.

5. The image forming system according to claim 1, wherein
the hardware processor of the first image forming device obtains, as the device information, address information of the information processing device that has sent the print job.

6. The image forming system according to claim 1, further comprising:
a plurality of image forming devices comprising the first image forming device, wherein
the hardware processor of the first photographing device further:
obtains identification information that identifies the first image forming device upon receiving the device information from the first image forming device; and
identifies the first image forming device based on the identification information, and
the imaging device photographs the image that settles the identified first image forming device within a range of photographing.

7. The image forming system according to claim 6, wherein
the hardware processor of the first photographing device further obtains location relation information that shows a location relation between the first image forming device and the first photographing device,
the first photographing device further comprises a photographing direction controller that adjusts a direction in which the imaging device photographs, and
the photographing direction controller adjusts the direction to a direction in which the identified first image forming device is settled in the range of photographing based on the location relation information.

8. The image forming system according to claim 6, comprising:
a plurality of photographing devices comprising the first photographing device and that each photograph at least one of the image forming devices, wherein
the hardware processor of the first photographing device further obtains related information that defines which of the photographing devices are enabled to photograph the respective image forming devices, and
when the related information defines one of the photographing devices as being enabled to photograph the identified first image forming device, the hardware processor of the first photographing device sends the image that shows the photographed first image forming device to the information processing device.

9. The image forming system according to claim 8, wherein
the hardware processor of the first image forming device broadcasts the device information.

10. The image forming system according to claim 6, comprising:
a plurality of photographing devices comprising the first photographing device, wherein
the hardware processor of the first image forming device further:
obtains related information that defines which of the photographing devices are enabled to photograph the first image forming device;
identifies one of the photographing devices that is enabled to photograph the first image forming device based on the related information; and
sends the device information to the identified first photographing device.

11. The image forming system according to claim 2, wherein the hardware processor of the first photographing device further:
detects a device image of the first image forming device in the image photographed by the imaging device; and
highlights the detected device image.

12. The image forming system according to claim 11, wherein
the hardware processor of the first photographing device further:
detects multiple device images in the image photographed by the imaging device;
obtains device image information that identifies the device image of the first image forming device that has sent the device information from among the multiple device images upon detecting the multiple device images;
identifies the device image of the first image forming device that has sent the device information from among the multiple device images based on the device image information; and
highlights the identified device image.

13. The image forming system according to claim 2, wherein the hardware processor of the first photographing device further:
detects a person image around the first image forming device in the image photographed by the imaging device; and
highlights the detected person image.

14. A photographing device that communicates with an image forming device over a network and is arranged at a position in which a photographing of the image forming device is enabled, the image forming device producing a printed output based on a print job sent by an information processing device, the photographing device comprising:
an imaging device that photographs an image that identifies a location of the image forming device; and
a hardware processor that:
obtains device information that identifies the information processing device used by a user to send the print job, from the image forming device that has received the print job; and
sends the image photographed by the imaging device to the information processing device based on the device information upon obtaining the device information.

15. An image forming device that communicates with a photographing device that is enabled to photograph the image forming device over a network, the image forming device comprising:
a hardware processor that:
obtains device information that identifies an information processing device that has sent a print job;
sends the device information to the photographing device upon receiving the print job;
enables the photographing device to photograph an image that identifies a location of the image forming device; and
enables the photographing device to send the photographed image to the information processing device based on the device information.

16. A non-transitory recording medium storing a computer readable program to be executed by a hardware processor in a photographing device that communicates with an image forming device over a network and is arranged at a position in which a photographing of the image forming device is enabled, the image forming device producing a printed output based on a print job sent by an information processing device, the hardware processor executing the program to execute:
photographing an image that identifies a location of the image forming device;
obtaining device information that identifies the information processing device used by a user to send the print job, from the image forming device that has received the print job; and
sending the photographed image to the information processing device based on the device information upon obtaining the device information.

17. A non-transitory recording medium storing a computer readable program to be executed by a hardware processor in an image forming device that communicates with a photographing device that is enabled to photograph the image forming device over a network, the hardware processor executing the program to execute:
obtaining device information that identifies an information processing device that has sent a print job;
sending the device information to the photographing device upon receiving the print job;
enabling the photographing device to photograph an image that identifies a location of the image forming device; and
enabling the photographing device to send the image to the information processing device based on the device information.
